(19) United States
(12) Patent Application Publication
(10) Pub. No.: US 2004/0075651 A1
(43) Pub. Date: Apr. 22, 2004

(54) Touch screen with improved transducer structure

(75) Inventor: Eric Cheng, Hsi-Chih City (TW)

Correspondence Address: QUINTERO LAW OFFICE, 1617 BROADWAY, 3RD FLOOR, SANTA MONICA, CA, 90404, US

(73) Assignee: Onetouch Technologies Co., Ltd.

(21) Appl. No.: 10/300,062

(22) Filed: Nov. 20, 2002

(30) Foreign Application Priority Data
Oct. 18, 2002 (TW) 091216662

(51) Int. Cl. G09G 5/00

(52) U.S. Cl. 345/173

(57) ABSTRACT

A touch screen with improved transducer structure, comprising: a plate having a top surface and a bottom surface for passing an acoustic wave on the top surface; at least one transducer positioned on the top surface for receiving the acoustic wave; and at least one supporter positioned on the top surface and adjacent to one side of the transducer, wherein the height of the supporter is higher than the height of the transducer for protecting the transducer.

### FIELD OF THE INVENTION

The present invention relates generally to a touch screen. More particularly, the present invention relates to a touch screen with improved transducer structure.

### BACKGROUND OF THE INVENTION

Referring first to FIG. 1 is an assembly view of a touch screen in accordance with the prior art. Previous touch screen consisting mainly of a plate 1, at least one transducer 2 and a plurality of acoustic amplifiers 3, wherein the transducer 2 is used for transmitting and receiving the acoustic wave, the acoustic amplifiers 3 are used for blocking and amplifying the acoustic wave and the shape of the acoustic amplifiers 3 are forming in oblique direction and the preceding is less density than the foregoing because of the foregoing acoustic wave is weakly, therefore needs a acoustic amplifiers 3 to amplify the acoustic wave.

Referring to FIG. 2 is a cross section, enlarged side view of a touch screen in accordance with the prior art. The transducer 2 is placed on the plate 1 and protruded from the surface of the plate 1 so as to transmit the acoustic wave. The plate 1 must be pressed on an outer frame of the monitor (not shown) during assembly, therefore, the transducer 2 could be damaged by the pressure of the outer frame of the monitor.

Referring to FIG. 3 is a cross section, enlarged side view of a touch screen in accordance with another prior art. The edge of the plate 1 is an inclined plane. The transducer 2 is placed on the edge of the plate 1 and protruded from the surface of the plate 1 so as to transmit the acoustic wave. The plate 1 must be pressed on an outer frame of the monitor (not shown) during assembly, therefore, either the transducer 2 could be damaged because of the pressure of the outer frame of the monitor or the plate 1 could be damaged because of the inclined plane.

Furthermore, R.O.C Patent Publication No. 484,090 issued to Tanaka et al. for “TOUCH SCREEN PANEL” which disclosed a touch screen panel, characteristic in: a panel having a first surface, a second surface and a connection surface, a transducer is placed on the second surface so as to transmit the acoustic wave to the first surface via the connection surface, such that, the plate 1 must be pressed on an glass of the monitor (not shown) during assembly, therefore, the transducer 2 could be damaged by the pressure of the glass of the monitor.

As a result, an improved touch screen with improved transducer structure that reduces damage by the pressure of the monitor is needed.

### SUMMARY OF THE INVENTION

It is an object of the present invention to provide a touch screen with improved transducer structure for protecting the transducer.

In accordance with one embodiment of the invention, an touch screen with improved transducer structure is provided comprising: a plate having a top surface and a bottom surface for passing an acoustic wave on the top surface; at least one transducer positioned on the top surface for receiving the acoustic wave; and at least one supporter positioned on the top surface and adjacent to one side of the transducer, wherein the height of the supporter is higher than the height of the transducer for protecting the transducer.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an assembly view of a touch screen in accordance with the prior art.

FIG. 2 is a cross section, enlarged side view of a touch screen in accordance with the prior art.

FIG. 3 is a cross section, enlarged side view of a touch screen in accordance with another prior art.

FIG. 4 is an assembly view of a touch screen with improved transducer structure in accordance with one embodiment of the present invention.

FIG. 5 is a cross section, enlarged side view of a touch screen with improved transducer structure in accordance with one embodiment of the present invention.

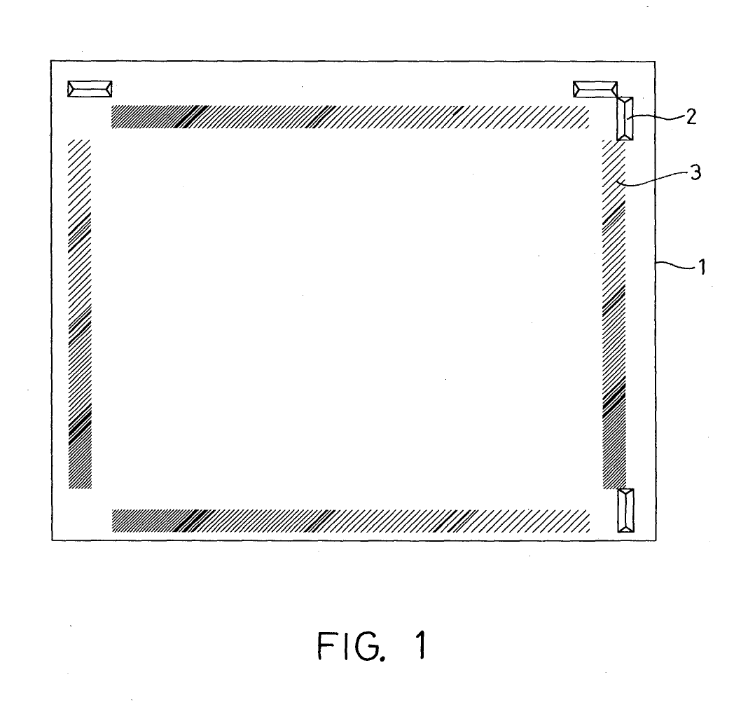

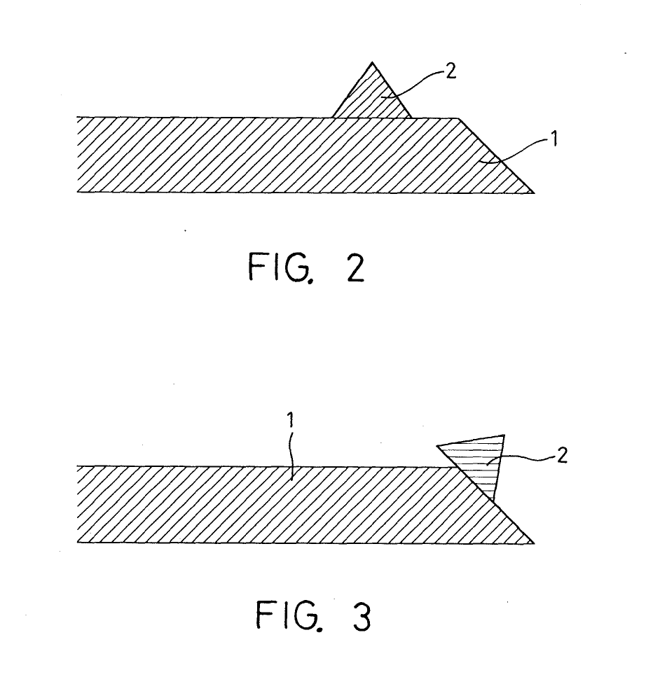

### DESCRIPTION OF THE PREFERRED EMBODIMENTS

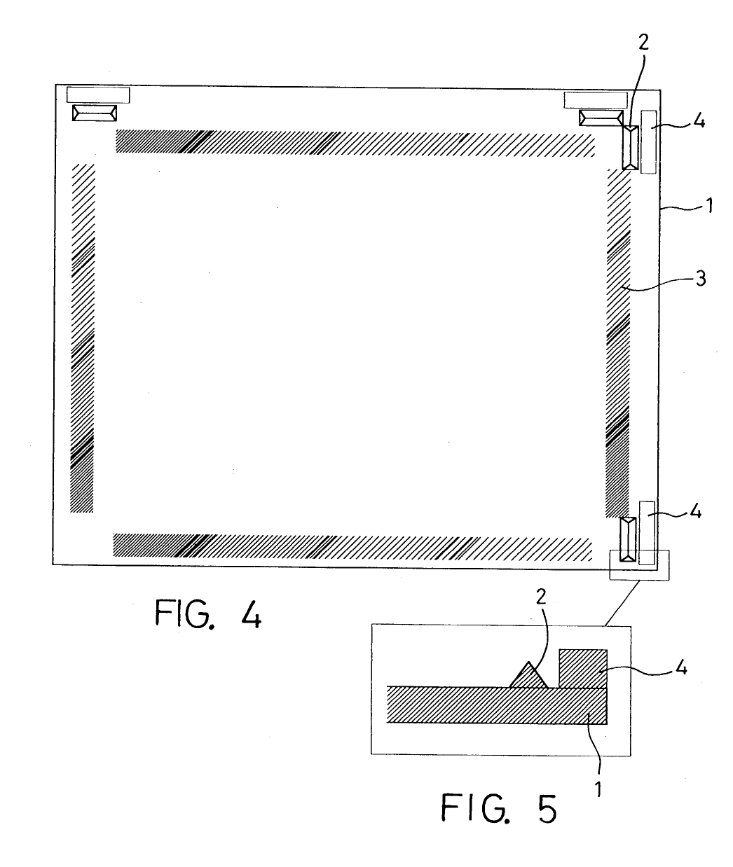

Referring to FIG. 4, there is shown an assembly view of a touch screen with improved transducer structure in accordance with one embodiment of the present invention. The touch screen with improved transducer structure comprises: a panel 1, at least one transducer 2, and at least one supporter 4.

Wherein, the plate 1 has a top surface 11 and a bottom surface 12 (not shown) for passing an acoustic wave on the top surface 11 furthermore, there are a plurality of acoustic amplifiers 3 are distributed on the top surface 11 for blocking and amplifying the acoustic wave and the shape of the acoustic amplifiers 3 are forming in oblique direction and the preceding is less density than the foregoing because of the foregoing acoustic wave is weakly, therefore needs a acoustic amplifiers 3 to amplify the acoustic wave.

Wherein, the transducer 2 is positioned on the top surface 11 of the panel 1 for receiving the acoustic wave, the transducer 2 of the present invention is a acoustic wave transmitter or receiver preferably; and the supporter 4 is positioned on the top surface 11 and adjacent to one of the transducer 2, wherein the height of the supporter 4 is higher than the height of the transducer 2 for protecting the transducer 2, such that the pressure of the glass of the monitor could be bear by the supporter 4 and the transducer 2 could be protected by the supporter 4. Wherein, the supporter 4 is example but not limit to make of plastic material, such as acrylic material, the panel 1 is example but not limit to make of glass material.

Referring to FIG. 5 is a cross section, enlarged side view of a touch screen with improved transducer structure in accordance with one embodiment of the present invention. The transducer 2 is positioned on the top surface 11 of the panel 1 and the supporter 4 is positioned outside of the transducer 2, the height of the supporter 4 is higher than the height of the transducer 2 for protecting the transducer 2, such that the pressure of the glass of the monitor could be bear by the supporter 4 and the transducer 2 could be protected by the supporter 4.

While the invention has been described with reference to a preferred embodiment thereof, it is to be understood that modifications or variations may be easily made without departing from the spirit of this invention, which is defined by the appended claims.

What is claimed is:

1. A Touch screen with improved transducer structure, comprising:
a plate having a top surface and a bottom surface for passing an acoustic wave on said top surface;
at least one transducer positioned on said top surface for receiving said acoustic wave; and
at least one supporter positioned on said top surface and adjacent to one side of said transducer, wherein the height of said supporter is higher than the height of said transducer for protecting said transducer.

2. A touch screen with improved transducer structure as claimed in claim 1, wherein the top surface of said plate further comprises a plurality of acoustic amplifiers for blocking and amplifying said acoustic wave.

3. A touch screen with improved transducer structure as claimed in claim 1, wherein said transducer is an acoustic transmitter preferably.

4. A touch screen with improved transducer structure as claimed in claim 1, wherein said transducer is an acoustic receiver preferably.

5. A touch screen with improved transducer structure as claimed in claim 1, wherein said plate is a glass preferably.

6. A touch screen with improved transducer structure as claimed in claim 1, wherein said supporter is a plastics material preferably.

7. A touch screen with improved transducer structure as claimed in claim 6, wherein said plastics material is an acrylic preferably.

8. A touch screen with improved transducer structure as claimed in claim 2, wherein said acoustic amplifiers are arrangement in oblique direction with said top surface.

9. A touch screen with improved transducer structure as claimed in claim 1, wherein said supporter is positioned at a corner of said plate.
